(19) United States
(12) Patent Application Publication
(10) Pub. No.: US 2018/0219653 A1
(43) Pub. Date: Aug. 2, 2018

(54) TRANSMISSION AND RECEPTION OF CODED SYSTEM INFORMATION

(71) Applicant: NOKIA SOLUTIONS AND NETWORKS OY, Espoo (FI)

(72) Inventors: Patrick Marsch, Wroclaw (PL); Maciej Januszewski, Pila (PL)

(21) Appl. No.: 15/747,304

(22) PCT Filed: Aug. 25, 2015
(86) PCT No.: PCT/EP2015/069434

§ 371 Date: Jan. 25, 2018

(51) Int. Cl. H04L 5/00; H04W 4/70; H04W 48/12; H04L 1/00

(52) U.S. Cl. CPC H04L 5/005; H04L 1/0061; H04W 48/12; H04W 4/70

(57) ABSTRACT

When waking up, a user equipment receives system configuration information in form of an ecoded signal (306). If the code has not changed from its previous value, then the user equipment access the system using the same system configuration information (310) saving effort and time, if the code has changed the UE obtains the whole system information (312) and then carries out the access to the system (314).

### TECHNICAL FIELD

The exemplary and non-limiting embodiments of the invention relate generally to communications.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

Originally wireless cellular systems have been used mainly for speech transmissions. The amount of data transmission has been in continuous increase due to digitalisation. In modern communication and computer networks, data exchange between programs and computers is a vital element. Different programs, computers and processors exchange data without human intervention. This kind of communication is usually called machine-to-machine (M2M) communications and this kind of communication is expected to become more and more common.

One example of apparatuses utilising M2M communication are small low-powered devices that are very constrained in cost and in power dissipation. They may be required to operate for years from a small battery or only have a limited own power source such as a tiny solar cell, for example. Typically these devices are most of the time in a sleep mode or in an inoperable state and not connected to any network. They may enter a wakeup-mode only now and then at perhaps irregular intervals. Due to the tight power dissipation constraints, it is essential that whenever these devices wake up to send data to a network, they are able to identify in a very power-efficient way how they can access the network.

### BRIEF DESCRIPTION

According to an aspect, there is provided the subject matter of the independent claims. Embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following the invention will be described in greater detail by means of preferred embodiments with reference to the accompanying drawings, in which

FIG. 1 illustrates an example of a communication environment;

FIGS. 2 and 3 are flowcharts illustrating embodiments of the invention;

FIGS. 4, 5 and 6 illustrate simplified examples of apparatuses applying some embodiments of the invention.

### DETAILED DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

Embodiments are applicable to any base station, user equipment (UE), server, corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UMTS) radio access network (UTRAN or E-UTRAN), long term evolution (LTE, known also as E-UTRA), long term evolution advanced (LTE-A), Wireless Local Area Network (WLAN) or Wi-Fi based on IEEE 802.11 standard, worldwide interoperability for microwave ac-cess (WiMAX), Bluetooth®, personal communications services (PCS) and systems using ultra-wideband (UWB) technology. IEEE refers to the Institute of Electrical and Electronics Engineers. LTE and LTE-A are developed by the Third Generation Partnership Project 3GPP.

In the following, exemplifying embodiments will be described using, as an example of an access architecture to which the embodiments may be applied, a radio access architecture based on long term evolution advanced (LTE Advanced, LTE-A). It is obvious for a person skilled in the art that the embodiments may also be applied to other kinds of communications networks having suitable means by adjusting parameters and procedures appropriately.

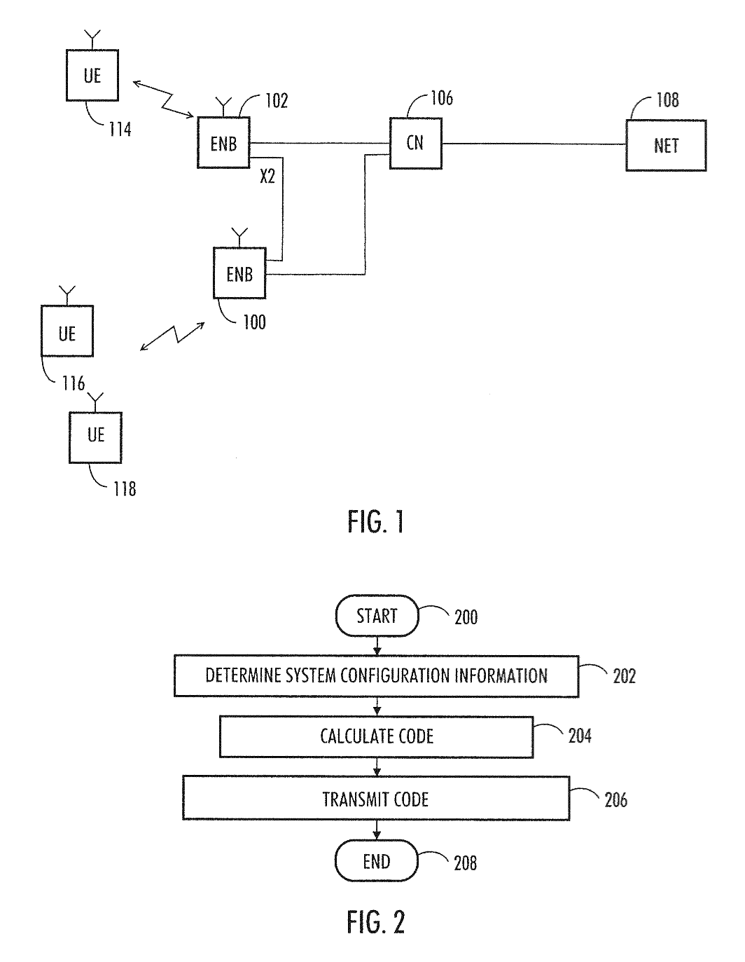

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

In the example of FIG. 1, a radio system based on long term evolution advanced (LTE Advanced, LTE-A) network elements is shown. However, the embodiments described in these examples are not limited to the LTE-A radio systems but can also be implemented in other radio systems.

FIG. 1 shows eNodeBs 100 and 102 connected to core network CN 106 of a communication system. The eNodeBs are connected to each other over an X2 interface.

The eNodeBs 100, 102 that may also be called base stations of the radio system may host the functions for Radio Resource Management: Radio Bearer Control, Radio Admission Control, Connection Mobility Control, Dynamic Resource Allocation (scheduling). Depending on the system, the counterpart on the CN side can be a serving gateway (S-GW, routing and forwarding user data packets), packet data network gateway (P-GW, for providing connectivity of user devices (UEs) to external packet data networks), and/or mobile management entity (MME), etc. The MME (not shown) is responsible for the overall user terminal control in mobility, session/call and state management with assistance of the eNodeBs through which the user terminals connect to the network.

The communication system is also able to communicate with other networks, such as a public switched telephone network or the Internet 108. The communication network may also be able to support the usage of cloud services. It should be appreciated that eNodeBs or their functionalities may be implemented by using any node, host, server or access point etc. entity suitable for such a usage.

Further, although the apparatuses have been depicted as single entities, different units, processors and/or memory units (not all shown in FIG. 1) may be implemented.

The user equipment UE (also called user device, user terminal, terminal device, etc.) illustrate one type of an apparatus to which resources on the air interface are allocated and assigned, and thus any feature described herein with a user device may be implemented with a corresponding apparatus.

The user equipment typically refers to a portable computing device that includes wireless mobile communication devices operating with or without a subscriber identification module (SIM). In general, user equipment may include the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

In addition, recent developments in computing and M2M communication have led to different types of user equipment which are small low-powered devices capable of performing different tasks and communicating with communication systems. Examples of these devices include sensors and other types of devices used, for example, in automation, measurement, tracking and control applications. Typically, the communication of these devices is M2M communication, i.e. they communicate with data connections with a server or computer, for example.

These typically low-power wireless devices are not continuously connected to the communication system. For conserving the limited operating power they may spend most of the time in a sleep- or standby-mode and enter a wakeup-mode only now and then. The waking up may be due to an external event or it may be internally caused. The waking up interval may be constant or it may be irregular.

In the example of FIG. 1, UE 114, when in wake-up mode, is connected to the eNodeB 102 using spectrum allocated to the communication system. UEs 116, 118, when in wake-up mode, are connected to eNodeB 100. One issue related to low-power devices utilising sleep-modes is that between two consecutive system accesses of a device the system configuration may have changed, either because the device has changed its location (e.g. it may be mounted to a moving object), or because the cell topology may have changed (e.g. cells turned off or new cells deployed), or because the configuration of the nearest cell has changed (e.g. different random access channel RACH parameters). When the device wakes up from a sleep-mode or standby-mode it should be able to connect to the communication system.

The device should be able to determine in a most energy-efficient way how it can access the system, considering that the system configuration may have changed.

Typically communication systems transmit on predetermined intervals system configuration information so that UEs which need to access the system get the information needed for sending a connection request. For example, in current LTE-based systems, after a device is powered on it has to perform the initial cell synchronization and read a Master Information Block (MIB) transmitted by each base station of the system. The MIB provides the very basic information about System Frame Number and downlink resource blocks, for example. This information is broadcasted with a 40 ms periodicity and repeated each 10 ms within that period. Next, the device has to access the System Information Block 1 (SIB-1) that broadcast information related to cell access. The information may comprise PLMN (public land mobile network) identity, Tracking Area Code, Cell ID, CSG (Closed Subscriber Group) indication, intra-frequency cell reselection info and information about the broadcast of other SIBs. The SIB-1 is broadcasted each 80 ms and is repeated every 20 ms during that period.

Depending on the situation, the device must acquire more than one SIB to obtain needed information. This process may take many hundreds of milliseconds. This is a big task for a low-power device.

Some proposals have been made to help obtaining the needed information. In order to avoid that devices constantly have to read SIB information, the system can inform devices through paging requests that they should read SIB, in case the information has changed. However, in the case of very power-constrained devices, it is desired that a device could go completely into sleep mode during in active periods (i.e. potentially for hours or even days), so devices would not be able to listen to these paging requests. This would mean that every time a device wakes up from a sleep-mode or standby-mode, it needs to synchronize to the cell it was camping on before and read the complete MIB, SIB1 and possible other SIBs, just in case the information therein may have changed. Only after reading this, the device would be able to access the system. This is very inefficient from an energy point of view.

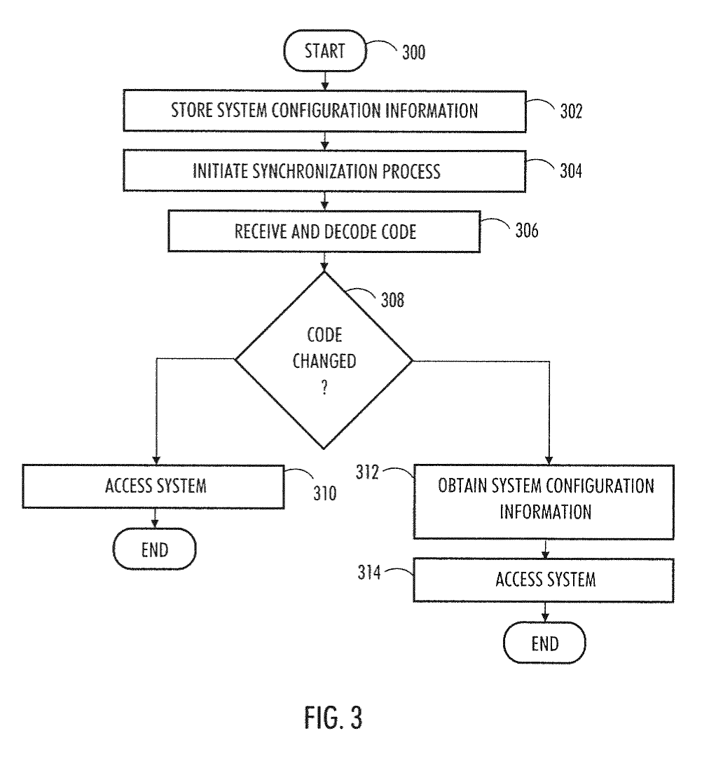

In LTE based systems, SIB1 contains a systeminfovaluetag-field, which is a counter from 0 to 31 and which is incremented each time the broadcast information changes allowing the devices to detect those changes easier. Even though the counter would allow detecting SIB changes also after the device wakes up from a sleep-mode or standby-mode it would not work with longer idle periods. In case a device leaves the RRC (Radio Resource Control) connected state or moves to a different cell the systeminfovaluetag-field cannot be used. FIG. 2 is a flowchart illustrating an embodiment of the invention. The embodiment starts at step 200. The example of FIG. 2 illustrates the operation of an apparatus which may be a network element or a base station or eNodeB or a part of a base station or eNodeB.

In step 202, the apparatus is configured to determine system configuration information of a given area served by the communication system. For example, the system configuration information may be the information transmitted by a base station of a cell. The system configuration information comprises information required to access the communication system. For example, in LTE-based systems the information may comprise the SIBs and possibly MIB.

In step 204, the apparatus is configured to calculate a code on the basis of the system configuration information. The code may be calculated by using a given hash function to obtain a hash code. In an embodiment, the code may be calculated as a checksum over the system configuration information. In an embodiment, the code may be a few bits long sequence (such as 8 or 16 bits).

The apparatus may be configured to ensure that any consecutive system configurations (at least those used during a period longer than the longest communication interval of any device) do not have the same code. This may be achieved by designing the hash function such that the system configuration information that is most frequently changed is presented in a higher number of bits than other information. Alternatively, upon changing the system configuration, some irrelevant bits may be changed to ensure that the resulting code is not the same as the previously used codes. Also, the hash function may be designed such that the resulting code cannot be the same as a given number of previously calculated codes, unless the system information is the same again as it was when the previous codes were used. Further, the hash function may be designed such that the resulting code cannot be the same as a given number of previously calculated codes in the current and adjacent cells. This latter aspect is especially advantageous in the context of moving devices, which could wake up in a different cell from where they were active before. Ultimately, it may not matter to the device whether it has changed cells; the only relevant aspect is whether the system configuration is the same as it was in the previous cell where the device was active.

In step 206, the apparatus is configured to control the transmission of the code. In an embodiment, the code may be transmitted at regular fixed intervals, such as 0.5 s for example. The interval as well as the points in time when the code is transmitted (e.g. in the form of time offsets relative to a common clock shared by the system and the devices) is known to devices camping on the cell served by the apparatus. The code may be transmitted on a suitable channel, such as a predetermined control channel known to devices camping on the cell. For example, the interval and their timing and the channel used in the transmission could be contained in the system configuration information such as SIB or similar form of information. In the case that low-power M2M devices are mobile, it may be ensured that the interval, absolute timing and channel through which the code is sent is the same for a large set of adjacent cells (e.g. all cells of an operator in a certain geographic area), so that the devices can correctly read this upon wake-up even if they have changed cells while sleeping.

The embodiment ends at step 208.

FIG. 3 is a flowchart illustrating an embodiment of the invention. The embodiment starts at step 300. The example of FIG. 3 illustrates the operation of an apparatus which may be user equipment or a part of user equipment, especially low-power user equipment.

In step 302, the apparatus is configured to store system configuration information of the communication system and a code calculated on the basis of the system configuration information. The apparatus, while being in active mode may have acquired the system configuration information which is required to access the system. The apparatus stores this information.

The apparatus may enter a standby- or sleep-mode. After an interval the apparatus wakes up from the standby- or sleep-mode. The apparatus may have determined information on transmission interval and timing of the code from the system configuration information. The expected waking time may have been synchronized to be a predetermined time interval prior to the reception time of the code on the basis of the information. The predetermined time interval may be selected on the basis of the expected time needed for the synchronization process. Possible clock mismatches may be taken into account when selecting the predetermined time interval.

In step 304, the apparatus is configured after waking up to initiate a synchronization process to the communication system the apparatus was camping on prior to entering the standby- or sleep-mode.

If the synchronization process is successful, the apparatus is in step 306 configured to receive and decode a code related to the system configuration information of the communication system. The apparatus may tune to a channel the code is known to be transmitted on.

In step 308, the apparatus is configured to determine if the code has changed since entering the standby- or sleep-mode. The apparatus may compare the received code with the code previously received and stored by the apparatus.

If the code has not changed the apparatus is configured in step 310 to access the system according to stored system configuration information. This system access may take the form of a random access approach, transmission of a connection request to the system, or a data transmission on a pre-defined resource, to name a few.

If the code has changed the apparatus is configured in step 312 to acquire from the communication system and store system configuration information.

In step 314, the apparatus is configured to access the system according to the acquired new system configuration information.

The proposed solution will lead to strongly reduced power dissipation at the UE side every time the UE wakes up and has to access the system by transmitting a request on RACH. Another advantage of unique code is that by checking the code the device could also detect whether it has changed cells (due to mobility or simply moving to another cell).

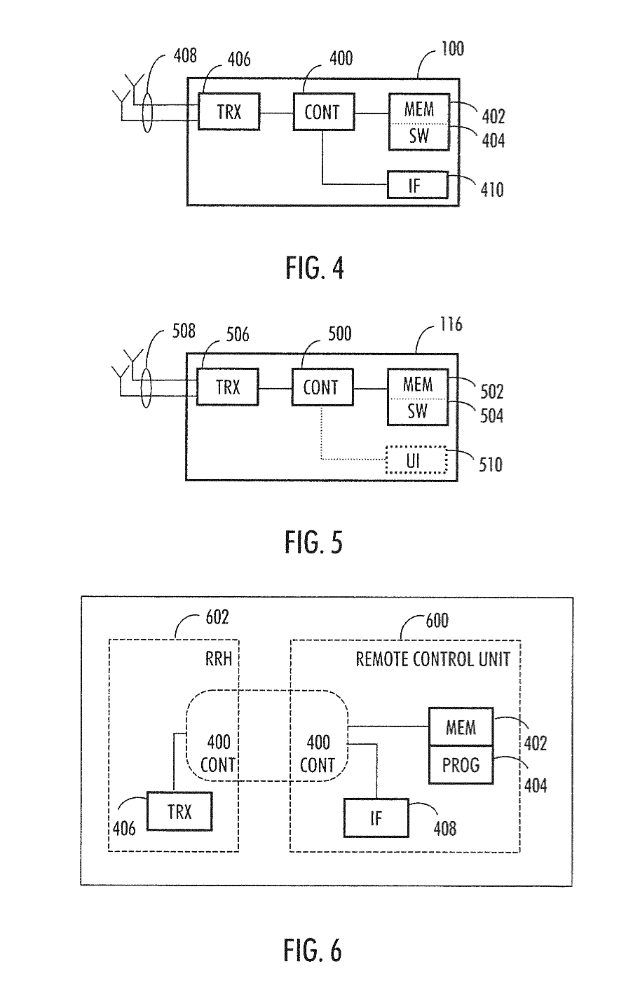

FIG. 4 illustrates an embodiment. The figure illustrates a simplified example of an apparatus in which embodiments of the invention may be applied. In some embodiments, the device may be a base station 100 or eNodeB or a part of an eNodeB communicating with a set of UEs.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus 100 of the example includes a control circuitry 400 configured to control at least part of the operation of the apparatus.

The apparatus may comprise a memory 402 for storing data. Furthermore the memory may store software 404 executable by the control circuitry 600. The memory may be integrated in the control circuitry.

The apparatus comprises a transceiver 406. The transceiver is operationally connected to the control circuitry 400. It may be connected to an antenna arrangement 408 comprising one more antenna elements or antennas.

The software 404 may comprise a computer program comprising program code means adapted to cause the control circuitry 400 of the apparatus to control a transceiver 406.

The apparatus may further comprise an interface 410 operationally connected to the control circuitry 400. The interface may connect the apparatus to other respective apparatuses such as eNodeB via X2 interface or to the core network.

The control circuitry 400 is configured to execute one or more applications. The applications may be stored in the memory 402. The applications may cause the apparatus to determine system configuration information of a given area served by the communication system; calculate a code on the basis of the system configuration information and control the transmission of the code, for example.

FIG. 5 illustrates an embodiment. The figure illustrates a simplified example of an apparatus in which embodiments of the invention may be applied. In some embodiments, the apparatus may be user equipment or a part of user equipment configured to communicate with an eNodeB.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus of the example includes a control circuitry 500 configured to control at least part of the operation of the apparatus.

The apparatus may comprise a memory 502 for storing data. Furthermore the memory may store software 504 executable by the control circuitry 600. The memory may be integrated in the control circuitry.

The apparatus comprises a transceiver 506. The transceiver is operationally connected to the control circuitry 500. It may be connected to an antenna arrangement 508 comprising one more antenna elements or antennas.

The software 504 may comprise a computer program comprising program code means adapted to cause the control circuitry 500 of the apparatus to control a transceiver 506.

In some embodiments, the apparatus may further comprise user interface 510 operationally connected to the control circuitry 500.

The control circuitry 500 is configured to execute one or more applications. The applications may be stored in the memory 502. The applications may cause the apparatus to store system configuration information of the communication system; and after waking up from a standby or sleep state to initiate a synchronization process to the communication system the apparatus was camping on prior entering the standby or sleep state; and if successful, receive and decode a code related to the system configuration information of the communication system, determine if the code has changed since entering the standby or sleep state; and if not, transmit a connection request utilizing stored system configuration information; and if yes, acquiring from the communication system and storing system configuration information prior transmitting the connection request, for example.

In an embodiment, as shown in FIG. 6, at least some of the functionalities of the apparatus of FIG. 4 may be shared between two physically separate devices, forming one operational entity. Therefore, the apparatus may be seen to depict the operational entity comprising one or more physically separate devices for executing at least some of the described processes. Thus, the apparatus of FIG. 6, utilizing such shared architecture, may comprise a remote control unit RCU 600, such as a host computer or a server computer, operatively coupled (e.g. via a wireless or wired network) to a remote radio head RRH 602 located in the base station. In an embodiment, at least some of the described processes may be performed by the RCU 600. In an embodiment, the execution of at least some of the described processes may be shared among the RRH 602 and the RCU 600.

In an embodiment, the RCU 600 may generate a virtual network through which the RCU 600 communicates with the RRH 602. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (e.g. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

In an embodiment, the apparatus implementing the invention comprises means for determining system configuration information of a given area served by the communication system; means for calculating a code on the basis of the system configuration information and means for controlling the transmission of the code.

In an embodiment, the apparatus implementing the invention comprises means for storing system configuration information of the communication system; means for receiving and decoding a code related to the system configuration information of the communication system after waking up from a standby- or sleep-mode initiating a successful synchronization process to the communication system the apparatus was camping on prior entering the standby- or sleep-mode; means for determining if the code has changed since entering the standby or sleep state; and if not, means for accessing the communication system utilizing stored system configuration information; and if yes, means for acquiring from the communication system and storing system configuration information prior to accessing the communication system according to this information.

It will be obvious to a person skilled in the art that, as the technology advances, the inventive concept can be implemented in various ways. The invention and its embodiments are not limited to the examples described above but may vary within the scope of the claims.

1. An apparatus of a communication system, comprising:
at least one processor and at least one memory including a computer program code, the at least one memory and the computer program code configured to, with the at least one processor, cause the apparatus at least to:
determine system configuration information of a given area served by the communication system;
calculate a code on the basis of the system configuration information when the system configuration information changes; and
control the transmission of the code.

2. The apparatus of claim 1, further configured to control the transmission of the code such that the code is transmitted at regular intervals.

3. (canceled)

4. The apparatus of claim 1, further configured to:
calculate the code such that the information is not the same as a given number of previously calculated codes in a given cell served by the apparatus and adjacent cells, unless the system information is the same as when the previously calculated codes were used.

5. The apparatus of claim 1, further configured to:
calculate the code as a checksum over the system configuration information.

6. The apparatus of claim 1, further configured to: control the transmission of the code in a pre-defined time and resource across many cells served by the communication system.

7. The apparatus of claim 2, further configured include information on the transmission interval and/or absolute or relative information on the transmission times of the system configuration information in the system configuration information.

8. The apparatus of claim 1, wherein the system configuration information comprises information required to access the communication system.

9. An apparatus of a communication system, comprising:
at least one processor and at least one memory including a computer program code, the at least one memory and the computer program code configured to, with the at least one processor, cause the apparatus at least to:
store system configuration information of the communication system;
receive and decode a code related to the system configuration information of the communication system after waking up from a standby- or sleep-mode and successfully initiating a synchronization process to the communication system the apparatus was camping on prior entering the standby- or sleep-mode,
determine if the code has changed since entering the standby or sleep state; and if not,
access the communication system utilizing stored system configuration information; and if yes,
acquire from the communication system and storing system configuration information prior to accessing the communication system according to this information.

10. The apparatus of claim 9, further configured prior entering a standby- or sleep-mode to:
determine information on the transmission interval and/or absolute or relative transmission times of the code from the stored the system configuration information;
synchronize expected waking time to be a predetermined time interval prior to the reception time of the code on the basis of the information.

11. The apparatus of claim 10, wherein the predetermined time interval is selected on the basis of expected time needed for the synchronization process.

12. The apparatus of claim 9, wherein the system configuration information comprises information required to access the communication system.

13.-20. (canceled)

21. A method in an apparatus of a communication system, comprising:
storing system configuration information of the communication system;
receiving and decoding a code related to the system configuration information of the communication system after waking up from a standby- or sleep-mode initiating a successful synchronization process to the communication system the apparatus was camping on prior entering the standby- or sleep-mode;
determining if the code has changed since entering the standby or sleep state; and if not,
accessing the communication system utilizing stored system configuration information; and if yes,
acquiring from the communication system and storing system configuration information prior to accessing the communication system according to this information.

22. The method of claim 21, further comprising prior entering a standby- or sleep-mode:
determining information on the transmission interval and/or absolute or relative transmission times of the code from the stored system configuration information;
synchronizing expected waking time to be a predetermined time interval prior to the reception time of the code on the basis of the information.

23. The method of claim 22, wherein the predetermined time interval is selected on the basis of expected time needed for the synchronization process.

24. The method of claim 21, wherein the system configuration information comprises information required to access the communication system.

25. A computer program product embodied on a distribution medium readable by a computer and comprising program instructions which, when loaded into an apparatus, execute the method according to claim 21.

26. The apparatus of claim 9, wherein the code is received at regular intervals and/or in a pre-defined time and resource.

27. The method of claim 21, wherein the code is received at regular intervals and/or in a pre-defined time and resource.

28. The apparatus of claim 9, wherein the received code is a checksum over the system configuration information.

29. The method of claim 21, wherein the received code is a checksum over the system configuration information.
